(19) United States
(12) Patent Application Publication
(10) Pub. No.: US 2011/0012569 A1
(43) Pub. Date: Jan. 20, 2011

(54) POWER DEVICE OF CLEAN REMOCON

(75) Inventor: Sung-Sub Lee, Gyeonggi-do (KR)

Correspondence Address: SCHWEGMAN, LUNDBERG & WOESSNER, P.A., P.O. BOX 2938, MINNEAPOLIS, MN, 55402, US

(73) Assignee: Seoby Electronic Co., Ltd, Gyeonggi-do (KR)

(21) Appl. No.: 12/933,583

(22) PCT Filed: Apr. 1, 2008
(86) PCT No.: PCT/KR2008/001827

§ 371 Date: Sep. 20, 2010

(30) Foreign Application Priority Data
Mar. 26, 2008 (KR) 10-2008-0027773

(51) Int. Cl. H02J 7/02

(52) U.S. Cl. 320/167

(57) ABSTRACT

Provided is a power device of a clean remote control that is designed to instantly and fully charge voltage required for driving the clean remote by supplying a commercial alternating current power using a super capacitor as a voltage storage unit. The clean remote control includes a key matrix, a controller, and a transceiver. The electric device includes a plug connected to a socket outlet supplying a commercial alternating current power, a rectification/constant-voltage unit for converting the commercial alternating current voltage supplied from the plug into a direct current voltage by rectifying the commercial alternating current power and for constantly maintaining the direct current voltage, a charging unit that is instantly and fully charged with the direct current voltage supplied from the rectification/constant-voltage, a controller for controlling an instant charge of the charging unit, and an over-voltage protection unit for preventing an excessive charge/discharge of the charging unit by monitoring the charging unit.

### TECHNICAL FIELD

The present invention relates to a power device of a clean remote control and, more particularly, to a power device of a clean remote control that is designed to instantly and fully charge a voltage required for driving the clean remote control by supplying a commercial alternating current power using a super capacitor as a voltage storage unit.

### BACKGROUND ART

Primary batteries formed of alkaline/lithium are used as power sources of conventional remote controls used for the remote operation of electronic devices.

The primary batteries used for the remote controls have a service life of about 6-12 months depending on the frequency of use.

When the primary battery of the remote control dies, the battery is replaced with a new primary battery. Reckless dumping of the used batteries leads to environmental pollution due to chemical materials within the used batteries. That is, the used batteries cause serious environmental problems.

In order to solve the environment problems caused by the used primary batteries, clean remote controls (rechargeable remote controls) that do not use primary batteries have been developed and used.

The clean remote controls typically include a generator or solenoid as a power generator and use a rechargeable (secondary) battery as a storage unit for storing a voltage generated by the power generator.

FIG. 9 is a graph of a charging characteristic curve of a conventional clean remote control.

Since the conventional remote control uses a small-sized generator or solenoid having limited capacity, it is time-consuming to charge the rechargeable battery by operating the generator or solenoid and the charging must be repeatedly performed many times (1, 2, 3, (n)).

However, since many pause times t1, t2, t3, . . . , and tn, are generated in the middle of operating the generator or solenoid, it takes several minutes or more to recharge the battery with a required voltage.

In addition, even when the clean remote control is designed to obtain the required voltage, the volume of the clean remote control is increased due to the many components thereof. This leads to an increase of the manufacturing cost and thus hurts price competitiveness.

Further, the clean remote control significantly generates noise in the course of generating the voltage and cannot provide a full charge for the secondary battery.

In addition, since power transmission for driving the generator is done by a mechanical mechanism, the remote control has a limited service life as the components thereof are worn by repeated motions.

Since the rechargeable battery is used in a state where it is not fully charged, a charging characteristic thereof is deteriorated due to a memory effect. Therefore, the charging capacity of the rechargeable battery is reduced and the charging period is gradually shortened, and the rechargeable battery is eventually discarded.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to solve the above problems and it is an object of the present invention to provide a power device of a clean remote control that is designed to instantly and fully charge a voltage required for driving the clean remote control by supplying a commercial alternating current power using a super capacitor as a voltage storage unit and to maintain the full charge in every recharging process, thereby preventing the generation of a memory effect in the super capacitor.

### Technical Solution

In order to achieve the above objects, an electric device of a clean remote control according to an exemplary embodiment to the present invention includes a key matrix for outputting a key value of a selected key with a specific voltage, a control unit for sending control codes matching with the key matrix, an oscillation unit for oscillating an operational frequency of a controller, and a transceiver for sending the control codes in accordance with a control of the controller and receiving the learned control code. The electric device is designed to be instantly and fully charged by a commercial alternating current power by being connected to a socket outlet and to supply operational power to the clean remote control.

A clean remote control of an exemplary embodiment of the present invention further includes a receiving groove formed on a portion of the clean remote control, a plug received in and hinge-coupled to the receiving groove, and a charging circuit that is connected to the plug and is quickly and fully charged by commercial alternating power.

In another exemplary embodiment, an electric device of a clean remote control having a key matrix, a controller, and a transceiver includes a plug connected to a socket outlet supplying a commercial alternating current power, a rectification/constant-voltage unit for converting the commercial alternating current voltage supplied from the plug into a direct current voltage by rectifying the commercial alternating current power and for constantly maintaining the direct current voltage, a charging unit that is instantly and fully charged with the direct current voltage supplied from the rectification/constant-voltage, a controller for controlling an instant charge of the charging unit, and an over-voltage protection unit for preventing an excessive charge/discharge of the charging unit by monitoring the charging unit.

### ADVANTAGEOUS EFFECTS

Since the clean remote control of the present invention uses the super capacitor as the charging unit, the clean remote control can instantly and fully recharge the voltage using the alternating current power without increasing the size thereof, thereby improving the charging efficiency and convenience.

Further, since the full charge is realized in every charging process, maximum charging efficiency and semi-permanent use will be possible. In addition, since the primary and secondary batteries are not used, a more eco-oriented clean remote control can be provided.

### BRIEF DESCRIPTION OF DRAWINGS

FIG. 1 is a block diagram of a clean remote control according to an exemplary embodiment of the present invention.

FIG. 2 is a schematic diagram of a power device of a remote controller according to an exemplary embodiment of the present invention.

FIGS. 3 and 4 are schematic diagrams of a power device module of a clean remote control according to a first exemplary embodiment of the present invention.

FIGS. 5 and 6 are schematic diagrams of a power device module of a clean remote control according to a second exemplary embodiment of the present invention.

FIG. 7 is a graph illustrating a charging characteristic of a power device of a clean remote control according to an exemplary embodiment of the present invention.

FIG. 8 is a graph illustrating a charging/discharging characteristic of a power device of a clean remote control according to an exemplary embodiment of the present invention.

FIG. 9 is a graph illustrating a charging characteristic of a conventional clean remote control.

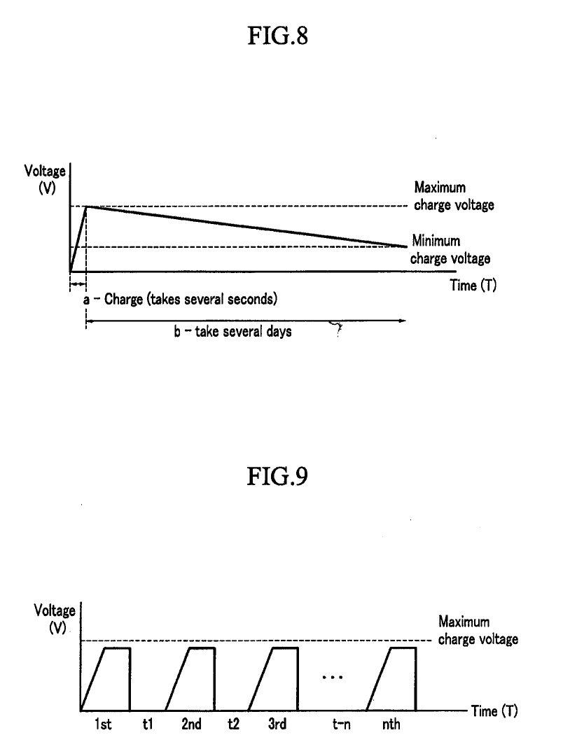

### BEST MODE

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

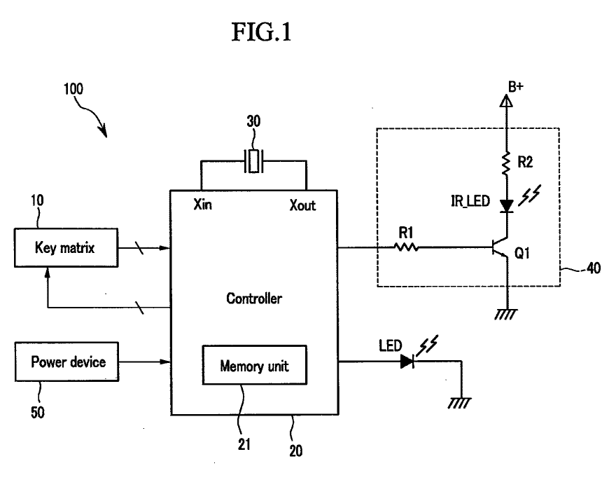

FIG. 1 is a block diagram of a clean remote control according to an exemplary embodiment of the present invention.

A remote control of the present invention includes a key matrix 10, a controller 20, an oscillator 30, a transceiver 40, and a power device 50.

The key matrix 10 includes a plurality of matrix contact points formed at the intersections of the X-axes and Y-axes. A unique output voltage is set at each of the contact points. The voltage is applied to the controller 20 when the corresponding contact point is activated to enable a selected key value to be recognized.

The key matrix 10 includes a power key, a device selection key, a channel selection key, a volume control key, number keys from 0 to 9, and a plurality of function keys.

The controller 20 is a microprocessor including an application program for remotely controlling a corresponding device and control codes of devices of respective manufacturers. The controller 20 accesses a control code related to the key value selected by the key matrix 10 and sends the control code to the corresponding device.

The controller 20 further includes a flash memory to store the learned control codes.

The oscillator 30 oscillates a frequency within a predetermined band that is required for operating the controller 20.

The transceiver 40 transmits an infrared signal corresponding to the control code to the device in accordance with a control signal of a square waveform pulse and receives the learned control codes.

The transceiver 40 includes a resistor R1 for adjusting an intensity of an output signal from the controller 20, a transistor Q1 that has an emitter terminal grounded and is switched in accordance with a signal applied to a base terminal through the resistor R1, and an infrared light emitting diode (IR LED) that is connected to a collector terminal of the transistor Q1 and emits light using electric power supplied through a resistor R2 in accordance with a switching operation of the transistor Q1 to transmit the control code.

The power device 50 includes at least one capacitor as a voltage storage unit. When the power device 50 is connected to a socket outlet, the capacitor is instantly and fully charged by a commercial alternating current power to supply electric power required for driving the clean remote control.

The clean remote control 100 includes a display unit (LED) displaying an operational state thereof.

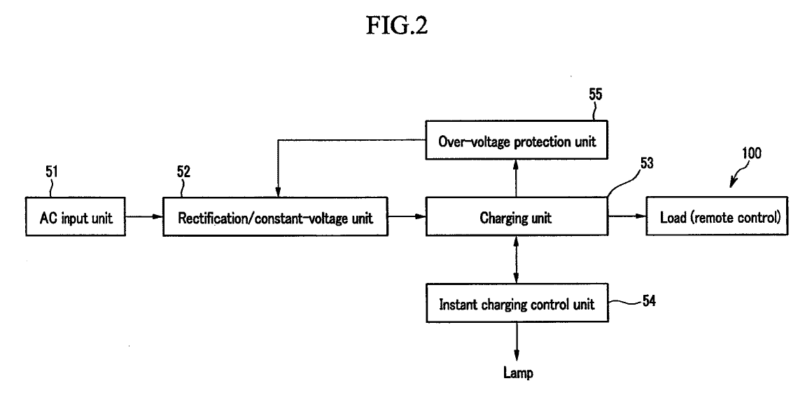

FIG. 2 is a schematic diagram of a power device of a clean remote controller according to an exemplary embodiment of the present invention.

As shown in FIG. 2, the power device includes an alternating current (AC) input unit 51, a rectification/constant-voltage unit 52, a charging unit 53, an instant charging control unit 54, and an over-voltage protection unit 55.

The AC input unit 51 is a power terminal formed of metal. The AC input unit 51 supplies the AC to the rectification/constant-voltage unit 52 by being connected to the socket outlet supplying the commercial AC power (110-230V).

The rectification/constant-voltage unit 52 converts the commercial AC power supplied to the AC input unit 51 into a direct current (DC) voltage by rectifying the commercial AC power. The rectification/constant-voltage unit 52 performs a voltage-down function for the DC voltage to make a constant-voltage.

The charging unit 53 is the super capacitor that can be instantly and fully charged with the DC voltage supplied through the rectification/constant-voltage unit 52 and supply an operational voltage to the clean remote control.

The charging unit 63 includes two or more super capacitors that are connected in series or parallel to adjust a use voltage of the clean remote control.

When it is assumed that the same capacity of the charging voltage is stored, the parallel connection may be better than the series connection to shorten the charging time and increase the charging capacity.

The super capacitor of the charging unit 53 includes two electrodes, a separator for insulating the electrodes from each other, and an exterior unit for receiving electrolyte as well as the electrodes and the separator.

Unlike a battery that converts chemical energy into electrical energy through an oxidation/reduction reaction, the super capacitor stores energy through a surface adsorption of electric charges on a boundary surface between the electrodes and the electrolyte and provides a quick charge/discharge.

The instant charging control unit 54 controls the charging unit 53 having the super capacitors such that the charging unit 53 can be instantly and reliably charged with the rectified DC voltage.

The over-voltage protection unit 55 monitors the charging unit 53 formed with the super capacitors to prevent the charging unit 53 from being over-charged with a voltage higher than a predetermined level and to prevent the charging unit 53 from being over-discharged with a voltage less than a predetermined level set in accordance with the discharge operation of the clean remote control 100, thereby preventing damage of the charging portion 53.

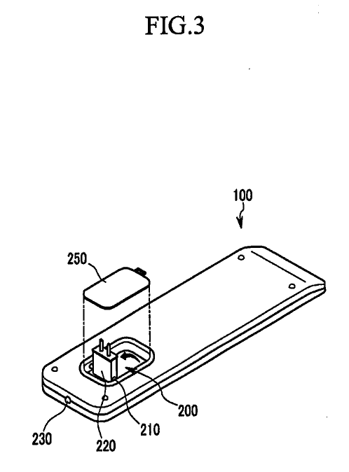

FIGS. 3 and 4 are schematic drawings of a power device module of a clean remote control according to a first exemplary embodiment, wherein the electric device is integrally formed with the clean remote control.

As shown in FIGS. 3 and 4, a receiving groove 200 is formed on a predetermined location (e.g., a rear surface) of the clean remote control 100. A plug 220 is received in the receiving groove 200 and coupled by a hinge 210.

The plug 220 rotates by 90° by the hinge 210 so that an electrode terminal 240 installed on the plug 220 can be connected to the socket outlet supplying the commercial AC power.

The plug 220 corresponds to the AC input unit 51 of FIG. 2.

That is, the plug 220 is electrically connected to the power device of FIG. 2.

As shown in FIG. 3, in order to perform the charging operation, the plug 220 protrudes by being rotated by 90° and is connected to the socket outlet supplying the commercial AC current.

After the charging operation is completed, as shown in FIG. 4, the plug 220 is rotated into the receiving groove 20.

At this point, the receiving groove 200 is closed by the cover 250 so that the plug 220 is not exposed during use of the clean remote control 100.

In addition, a lamp 230 indicating a charging state is installed at a predetermined location.

The following will describe the above-described built-in power device of the clean remote control.

When a voltage charge is requested, the lamp 230 indicating a voltage charge state is turned on to emit light (e.g., red light).

At this point, the cover 250 is separated from the rear surface of the clean remote control and the plug 220 is pulled in an arrow direction. Then, the plug 220 rotates about an axis of the hinge 210 to protrude as shown in FIG. 3.

After the plug 220 is rotated by 90° relative to the clean remote control, the electron terminal 240 is connected to the socket outlet supplying the commercial AC power. Then, the rectification/constant-voltage unit 52 that is an internal power circuit rectifies the commercial AC power supplied through the plug 220, i.e., through the AC input unit 10 to convert the AC power into the DC voltage. Subsequently, the rectification/constant-voltage unit 52 performs a voltage-down operation for the DC voltage to apply a constant-voltage to the charging unit 53.

The charging unit 53 formed with the super capacitors is instantly and fully charged with the DC voltage supplied through the rectification/constant-voltage unit 52 and supplies operational power to the clean remote control 100.

At this point, the instant charging control unit 54 controls the power device such that the instant charge can be stably realized by the rectified DC voltage supplied from the rectification/constant-voltage unit 52 to the charging unit 53.

In addition, the over-voltage protection unit 55 monitors the charging unit 53 formed with the super capacitors to prevent the charging unit 53 from being overcharged with a voltage higher than a predetermined level.

When the charging unit 53 formed with the super capacitors is quickly charged with the predetermined voltage, the lamp is turned on to emit light (e.g., green light) to indicate to the user the full charge.

At this point, the plug 220 is separated from the socket outlet and, as shown in FIG. 4, is rotated by 90° in an arrow direction. Then, the plug 220 is received in the receiving groove 200, after which the receiving groove 200 is closed by the cover 250.

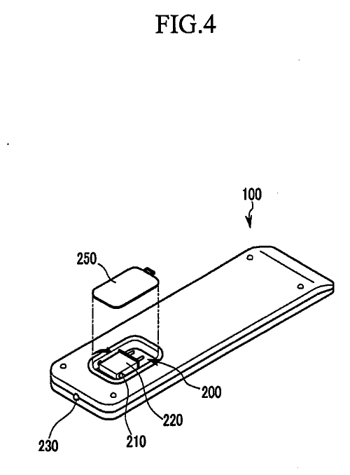

FIGS. 5 and 6 are schematic drawings of a power device module of a clean remote control according to a first exemplar embodiment, wherein the electric device is independently formed from the clean remote control.

A receiving groove 400 is defined by a stepped space formed on a side of a clean remote control 100. An electrode 321 is installed on a surface of the receiving groove 400 and a fitting groove 311 is formed on a vertical surface of the receiving groove 200.

A power device 300 formed in an independent module and coupled to the receiving groove 400 has a first electrode terminal 310 that is fitted in the fitting groove 311 and is connected to the socket outlet supplying the commercial AC power when the power device 300 is received in the receiving groove 400 for the charge.

A second electrode terminal 320 is installed on a lower portion of a body of the power device 300. The second electrode terminal 320 is connected to the electrode 321 to supply the voltage charged in the power device 300 to the clean remote control 100 when the power device 300 formed in the independent module is coupled to the receiving groove 400.

A lamp 330 indicating a voltage charge state is installed on a predetermined location of the power device 300.

The following will describe a charging process of the power device formed in the independent module.

When there is a need to charge the electric device 300 depending on the use of the clean remote control, the lamp 330 installed on the power device 300 is turned on to emit red light requesting the user to charge the electric device.

Accordingly, the power device 300 is separated from the clean remote control and the second electrode terminal 310 is connected to the socket outlet supplying the commercial AC power. Then, as described with reference to FIGS. 3 and 4, the voltage required for driving the clean remote control is instantly and fully charged in the charging unit 53 formed with the super capacitors.

When the charging unit 53 is fully charged, the lamp emits the green light to indicate to the user the full charge.

When the power device 300 is separated from the socket outlet and is connected to the clean remote control 100 as shown in FIG. 5, the second electrode terminal 320 installed on the lower portion of the power device 300 is connected to the electrode 321 installed on the clean remote control 100 to supply the operational voltage from the power device 300 to the clean remote control 100.

When the instant full charge of the power device 300 is realized, the power device 300 is separated from the socket outlet and is coupled to the receiving groove 400 in a state where the first electrode terminal 310 is fitted in the fitting groove 311 formed on the clean remote control.

When the power device formed in the independent module is coupled to the receiving groove 400, the second electrode 320 installed on a lower portion of the power device 300 is coupled to the electrode 321 installed on the receiving groove 400 to supply the operational power from the power device 300 to the clean remote control 100.

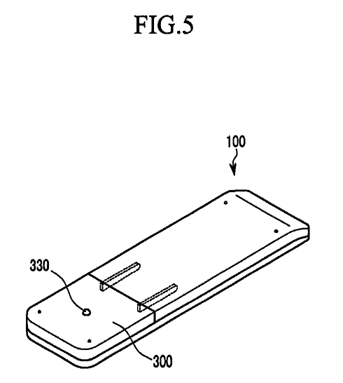

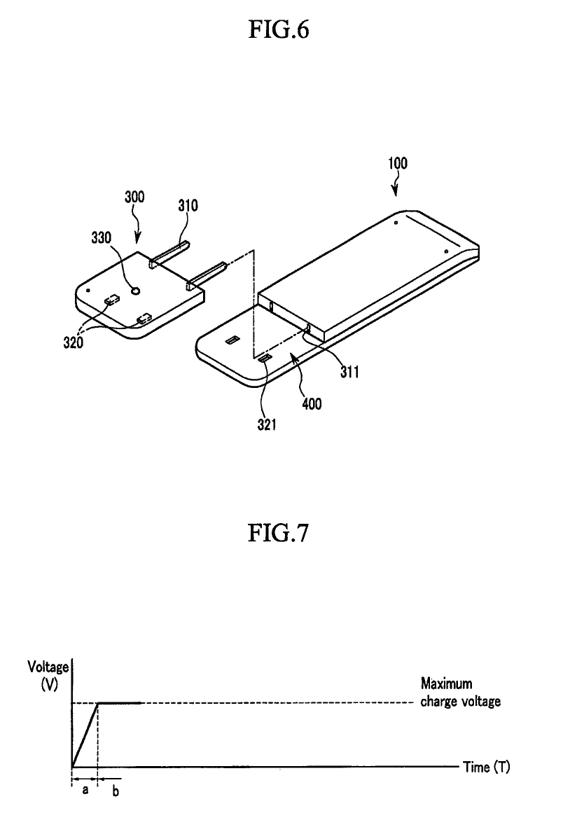

FIG. 7 is a graph illustrating a charging characteristic of a power device of a clean remote control according to an embodiment of the present invention and FIG. 8 is a graph illustrating a charging/discharging characteristic of a power device of a clean remote control according to an embodiment of the present invention.

When the plug of the power device is connected to the socket outlet as described above, a relatively high voltage of a rating DC current flows to the charging unit formed with the super capacitors which are instantly and fully charged (section a) and the stable full charge is maintained (section b).

Since the operation voltage of the clean remote control 100 is consumed by a current of several mA for a stroke of a key of the clean remote control, the clean remote control has a discharge period of several tens of days on a single charging of the electric device.

That is, the clean remote control can be used for several weeks or several tens of days on a single charging and has a discharge period of several tens of days on a single charging taking a short time. In addition, since the full charge is realized on every charging, no memory effect occurs.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electric device of a clean remote control, comprising:
a key matrix for outputting a key value of a selected key with a specific voltage;
a control unit for sending control codes matching with the key matrix;
an oscillation unit for oscillating an operational frequency of a controller; and
a transceiver for sending the control codes in accordance with a control of the controller and receiving the learned control code,
wherein the electric device is designed to be instantly and fully charged by a commercial alternating current power by being connected to a socket outlet and to supply operational power to the clean remote control.

2. The electric device of claim 1, wherein the electric device includes at least one super capacitor as a voltage charging unit.

3. The electric device of claim 1, wherein the electric device is integrally formed with the clean remote control or is formed as an independent module from the power device.

4. The electric device of claim 1, wherein the electric device comprises:
an alternating current unit that is a power terminal formed of metal and connected to a socket outlet supplying the commercial alternating current power;
a rectification/constant voltage unit for converting the commercial alternating current voltage supplied through the alternating current input unit into a direct current voltage by rectifying the commercial alternating current power and constantly maintaining the converted direct current voltage through a voltage-down;
a charging unit that is formed with a super capacitor and is instantly and fully charged by the direct current voltage supplied from the rectification/constant-voltage unit;
a constant charge control unit for controlling a constant charge of the charging unit; and
an over-voltage protection unit for preventing excessive charge/discharge by monitoring the charging unit.

5. The electric device of claim 4, further comprising an over-voltage protection unit for preventing excessive charge/discharge by monitoring the charging unit.

6. The electric device of claim 4, wherein the charging unit includes at least two super capacitors that are connected in parallel or series.

7. A power device of a clean remote control, comprising:
a receiving groove formed on a portion of the clean remote control;
a plug received in and hinge-coupled to the receiving groove; and
a charging circuit that is connected to the plug and is quickly and fully charged by commercial alternating power.

8. The power device of claim 7, wherein the clean remote control further comprises a cover coupled to a receiving groove.

9. The power device of claim 7, wherein the plug hinge-coupled to the receiving groove is capable of rotating by 90°.

10. The power device of claim 7, wherein the clean remote control further comprises a lamp indicating a charging state.

11. A power device of a clean remote control, comprising:
a clean remote control including an electrode and provided with a fitting groove; and
a power module that is fitted in a fitting groove of the clean remote control and includes a first electrode terminal connected to a socket outlet supplying commercial alternating current power during charging and a second electrode terminal that is coupled to a terminal of the clean remote control to supply electric power to the clean remote control.

12. The power device of claim 11, wherein the power module is formed in an independent module separated from the clean remote control.

13. The power device of claim 11, wherein the clean remote control is provided with a stepped space defining a receiving groove of the power module.

14. The power device of claim 11, wherein the power module comprises a lamp indicating a charging state.

15. An electric device of a clean remote control having a key matrix, a controller, and a transceiver, the electric device comprising:
a plug connected to a socket outlet supplying a commercial alternating current power;
a rectification/constant-voltage unit for converting the commercial alternating current voltage supplied from the plug into a direct current voltage by rectifying the commercial alternating current power and for constantly maintaining the direct current voltage;
a charging unit that is instantly and fully charged with the direct current voltage supplied from the rectification/constant-voltage;
a controller for controlling an instant charge of the charging unit; and
an over-voltage protection unit for preventing an excessive charge/discharge of the charging unit by monitoring the charging unit.

16. The power device of claim 15, wherein the rectification/constant-voltage unit provides full charge by supplying high electric current to a rate direct current in accordance with a capacity of the charging unit.
